(19) United States
(12) Patent Application Publication
(10) Pub. No.: US 2023/0032739 A1
(43) Pub. Date: Feb. 2, 2023

(54) PROPENSITY MODELING PROCESS FOR CUSTOMER TARGETING

(71) Applicant: Dell Products L.P., Round Rock, TX (US)

(72) Inventors: Arnaud De Jaegher, Bratislava (SK); Amihai Savir, Sansana (IL); Lukas Cerveny, Bratislava (SK); Ondrej Jariabka, Turcianske Teplice (SK)

(73) Assignee: Dell Products L.P., Round Rock, TX (US)

(21) Appl. No.: 17/388,864

(22) Filed: Jul. 29, 2021

(51) Int. Cl. G06Q 30/02; G06N 20/00; G06N 5/04; G06F 16/28; G06Q 30/00

(52) U.S. Cl. CPC G06Q 30/0204; G06N 20/00; G06N 5/04; G06F 16/285; G06Q 30/0251; G06Q 30/016

(57) ABSTRACT

In one aspect, an example methodology implementing the disclosed techniques includes receiving a historical customer dataset, the historical customer dataset reflective of pre-purchase, purchase, and post-purchase stages of a consumption process of a plurality of customers and identifying a plurality of first features, the plurality of first features derived from the historical customer dataset. The method also includes generating a first training dataset from the plurality of first features, training a first machine learning (ML) model using the first training dataset, and determining, using the first ML model, a plurality of second features. The method further includes generating a second training dataset from the plurality of second features and training a second ML model using the second training dataset, wherein the second ML model is trained to output propensity predictions for the plurality of customers.

### BACKGROUND

Enterprises, such as companies, business organizations, corporations, agencies, and governmental agencies, commonly use marketing campaigns to reach customers and potential customers and create leads. For example, marketing campaigns are often used by enterprises to promote and sell a product or service. To illustrate, marketing campaigns may include targeted actions or events, such as targeted emails, targeted giveaways, or some other communication events, to contact and persuade potential customers to try the product or service being marketed. When leveraged to the proper customer audience, these marketing campaigns can greatly influence the way enterprises generate profits, sales, and growth. However, if a marketing campaign is not properly targeted, there is the risk that the marketing campaign will be counterproductive and damage profits and sales as well as harm an enterprise's image/brand.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a computer implemented method for customer targeting for a marketing campaign includes receiving a historical customer dataset, the historical customer dataset reflective of pre-purchase, purchase, and post-purchase stages of a consumption process of a plurality of customers and identifying a plurality of first features, the plurality of first features derived from the historical customer dataset. The method also includes generating a first training dataset from the plurality of first features, training a first machine learning (ML) model using the first training dataset, and determining, using the first ML model, a plurality of second features. The method further includes generating a second training dataset from the plurality of second features and training a second ML model using the second training dataset, wherein the second ML model is trained to output propensity predictions for the plurality of customers.

In some embodiments, identifying the plurality of first features includes: performing a first dimensionality reduction on the historical customer dataset; clustering the first dimensionally reduced historical customer dataset into a plurality of first level (L1) clusters; for each L1 cluster of the plurality of L1 clusters: performing a second dimensionality reduction on data points in an L1 cluster; and clustering the second dimensionally reduced data points in the L1 cluster into a plurality of second level (L2) clusters; and sampling from the L2 clusters to achieve a uniform distribution of the L2 clusters.

In some embodiments, sampling from the L2 clusters to achieve a uniform distribution of the L2 clusters results in a reduction of inherent bias in the historical customer dataset.

In some embodiments, clustering the first dimensionally reduced historical customer dataset into the plurality of L1 clusters is via one of k-means clustering or k-medoids clustering.

In some embodiments, a number of L1 clusters in the plurality of L1 clusters is determined via one of an elbow method or gap statistics.

In some embodiments, the L2 clusters of the plurality of L2 clusters is more granular than the L1 clusters of the plurality of L1 clusters.

In some embodiments, the plurality of second features is more relevant to the propensity predictions than the plurality of first features.

In some embodiments, the propensity predictions include likelihood to make a purchase.

In some embodiments, the propensity predictions include likelihood to make a return.

In some embodiments, the propensity predictions include likelihood to require assistance.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to receive a historical customer dataset, the historical customer dataset reflective of pre-purchase, purchase, and post-purchase stages of a consumption process of a plurality of customers, and identify a plurality of first features, the plurality of first features derived from the historical customer dataset. Execution of the instructions also causes the one or more processors to generate a first training dataset from the plurality of first features, train a first machine learning (ML) model using the first training dataset, and determine, using the first ML model, a plurality of second features. Execution of the instructions further causes the one or more processors to generate a second training dataset from the plurality of second features and train a second ML model using the second training dataset, wherein the second ML model is trained to output propensity predictions for the plurality of customers.

In some embodiments, to identify the plurality of first features includes: perform a first dimensionality reduction on the historical customer dataset; cluster the first dimensionally reduced historical customer dataset into a plurality of first level (L1) clusters; for each L1 cluster of the plurality of L1 clusters: perform a second dimensionality reduction on data points in an L1 cluster; and cluster the second dimensionally reduced data points in the L1 cluster into a plurality of second level (L2) clusters; and sample from the L2 clusters to achieve a uniform distribution of the L2 clusters.

In some embodiments, to sample from the L2 clusters to achieve a uniform distribution of the L2 clusters results in a reduction of inherent bias in the historical customer dataset.

In some embodiments, to cluster the first dimensionally reduced historical customer dataset into the plurality of L1 clusters is via one of k-means clustering or k-medoids clustering.

In some embodiments, a number of L1 clusters in the plurality of L1 clusters is determined via one of an elbow method or gap statistics.

In some embodiments, the L2 clusters of the plurality of L2 clusters is more granular than the L1 clusters of the plurality of L1 clusters.

According to another illustrative embodiment provided to illustrate the broader concepts described herein, a computer program product includes one or more non-transitory machine-readable mediums encoding instructions that when executed by one or more processors cause a process to be carried out for customer targeting for a marketing campaign. The process includes receiving a historical customer dataset, the historical customer dataset reflective of pre-purchase, purchase, and post-purchase stages of a consumption process of a plurality of customers and identifying a plurality of first features, the plurality of first features derived from the historical customer dataset. The process also includes generating a first training dataset from the plurality of first features, training a first machine learning (ML) model using the first training dataset, and determining, using the first ML model, a plurality of second features. The process further includes generating a second training dataset from the plurality of second features and training a second ML model using the second training dataset, wherein the second ML model is trained to output propensity predictions for the plurality of customers.

In some embodiments, identifying the plurality of first features includes: performing a first dimensionality reduction on the historical customer dataset; clustering the first dimensionally reduced historical customer dataset into a plurality of first level (L1) clusters; for each L1 cluster of the plurality of L1 clusters: performing a second dimensionality reduction on data points in an L1 cluster; and clustering the second dimensionally reduced data points in the L1 cluster into a plurality of second level (L2) clusters; and sampling from the L2 clusters to achieve a uniform distribution of the L2 clusters.

In some embodiments, sampling from the L2 clusters to achieve a uniform distribution of the L2 clusters results in a reduction of inherent bias in the historical customer dataset.

In some embodiments, the L2 clusters of the plurality of L2 clusters is more granular than the L1 clusters of the plurality of L1 clusters.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 shows an illustrative workflow for a propensity modeling process, in accordance with an embodiment of the present disclosure.

FIG. 2 is a block diagram illustrating selective components of an example targeted marketing system in which various aspects of the disclosure may be implemented, in accordance with an embodiment of the present disclosure.

FIG. 3 is a flow diagram of an illustrative sampling process, in accordance with an embodiment of the present disclosure.

FIG. 4 is a diagram of an illustrative two-stage process for optimizing a feature selector and a machine learning (ML) model, in accordance with an embodiment of the present disclosure.

FIG. 5 is a block diagram illustrating selective components of an example computing device in which various aspects of the disclosure may be implemented, in accordance with an embodiment of the present disclosure.

### DETAILED DESCRIPTION

As noted above, marketing campaigns that are not properly targeted can be counterproductive and can negatively impact profits and sales as well as cause harm to an enterprise's image/brand. Determining a customer audience for a marketing campaign is a persistent, time consuming, and expensive endeavor for enterprises. Enterprises commonly rely on static rules that are based on customer lists and purchase history data (e.g., purchasing habits and trends) to determine a customer's intent to purchase a product or a service and, based on such determinations, identify a target customer audience for a marketing campaign. However, these static rules typically only account for the customers' buying experience. Unfortunately, the buying experience is only a small portion of the comprehensive, end-to-end (E2E) customer journey during all stages of the consumption process, which typically includes pre-purchase, purchase, and post-purchase (e.g., support, retention (loyalty), etc.) stages. Moreover, these static rules are applied within an inflexible framework which is very complex, difficult to build, and which failed to consider many of the parameters that impact the success of a marketing campaign. The advent of global businesses and fast evolving business environment and customer landscape only adds to the challenge of using these static rules and an inflexible framework to determine a proper customer audience.

It would also greatly benefit enterprises to be able to determine the effectiveness (performance) of a marketing campaign directed to a targeted customer audience prior to deploying (launching) the marketing campaign. For example, this information would allow an enterprise to decide whether to actually deploy the marketing campaign, not deploy the marketing campaign, or expend additional resources to make modifications to the marketing campaign and/or the target customer audience. However, enterprises are increasing outsourcing all or significant portions of their campaign development to third-party vendors. For example, an enterprise may provide their data (e.g., customer lists and purchase history data) and specify a business objective to a vendor, and the vendor will develop a marketing campaign for the specified business object for use by the enterprise. Here, the marketing campaign is, in effect, a “black box” to the enterprise since the enterprise has no visibility to the logic behind the outcome of the marketing campaign. Moreover, without this visibility, the enterprise is unable to determine the effectiveness of the marketing campaign without actually deploying and conducting the marketing campaign.

Thus, in accordance with some of the embodiments disclosed herein, an agnostic propensity modeling process and framework are described for customer targeting for a marketing campaign. The modeling process can be used to train a learning model (e.g., a machine learning (ML) model for propensity scoring) using machine learning techniques (including neural networks) with historical customer data to predict a propensity of a customer to perform an action. As used herein, the term “customer” refers, in addition to its plain and ordinary meaning, to a current customer, a past customer, a potential customer, or an individual (e.g., a person) or entity that the enterprise desires to acquire as a customer. The predicted customer propensity (customer behavior) may facilitate customer targeting for marketing campaigns. For example, the predicted propensity of a customer to perform an action, such as a propensity to purchase a particular type of product, may be utilized to determine whether the customer is or is not to be a target for a marketing campaign regarding that particular type of product. Since the disclosed modeling process and framework is agnostic, the customer targeting can be for any type of marketing campaign and is only constrained by the availability of the historical customer data used during the process to train the model.

According to some embodiments, the propensity modeling process (sometimes referred to herein more simply as a “modeling process”) provides for highly efficient and accurate predictions that are based on comprehensive, end-to end customer experience data. In particular, the modeling process leverages historical customer data which incorporates the whole (complete), end-to-end customer journey through the pre-purchase, purchase, and post-purchase (e.g., support, retention (loyalty), etc.) stages of the customers' consumption process. In general, integrating the whole customer journey in the modeling process improves accuracy of the customer targeting since more parameters regarding the customers are integrated in and considered during the modeling process.

In some embodiments, the modeling process incudes a data sampling procedure that minimizes (and ideally eliminates) the bias that is present in the historical customer dataset while conserving the information (i.e., meaningful properties) conveyed by the historical customer data. It is appreciated herein that that the historical customer dataset may include a large number and, in many cases, a very large number of historical customer observations. It is also appreciated that the historical customer dataset may be biased where certain customer behaviors are overrepresented while other behaviors are underrepresented. For example, a very large percentage of the data the historical customer dataset may be regarding prospective customers (i.e., customers that did not make a product purchase) for which only demographic information is available and a very small percentage of the data regarding customers that purchased a product. As another example, a very large percentage of the data in the historical customer dataset may be regarding small, individual customers and a very small percentage of the data regarding large, institutional customers. As still another example, a very large percentage of the data in the historical customer dataset may be regarding customers that did not communicate with the enterprise's technical support center and a very small percentage of the data regarding customers that communicated with the technical support center. In any such cases, using an imbalanced training dataset will cause the model to mostly learn from the overrepresented group(s) and possibly ignore the underrepresented group(s).

Various embodiments of the data sampling procedure described herein meaningfully reduces the size of the historical customer dataset to a manageable size without comprise to the information conveyed by the historical customer data (e.g., information regarding the whole, end-to-end customer journey). As a result of the reduction in size, the modeling process is able to be performed in a reasonable timeframe. In addition, the data sampling procedure can balance the various groups that are present in the historical customer dataset to minimize (and ideally eliminate) the bias in terms of overrepresented data in the historical customer dataset. Minimizing the bias allows the model to learn from a more balanced training dataset. In other words, the model does not focus on a majority group(s) (i.e., overrepresented data) but, rather, considers all groups during the learning process.

In some embodiments, the data sampling procedure can include dimensionality reduction of the historical customer dataset to reduce the number of input variables (also known as features) in the historical customer dataset. The number of input variables or features for a dataset is referred to as its dimensionality. It is appreciated that the historical customer dataset may be too voluminous in its raw state to be modeled by predictive modeling algorithms directly. Dimensionality reduction is a process of automatically reducing the dimensionality of these types of observations (e.g., high dimensional historical customer dataset) into a much smaller, manageable dataset that can be modeled. The dimensionally reduced dataset also retains some of the meaningful properties of the original high dimensional dataset.

In some embodiments, the data sampling procedure can include a multi-level clustering of the historical customer dataset (e.g., the dimensionally reduced historical customer dataset) to balance the groups present in the historical customer dataset. In the multi-level clustering approach, the population or data points (e.g., the customers) in the historical customer dataset may be clustered into an optimal number of first level (L1) clusters. The L1 clustering may generate multiple (e.g., two, three, four, or more) clusters (or groups) of customers based on broad, high-level themes (e.g., customers that visited the website, customers for which only demographic data is available, etc.). These broad L1 clusters may not be suitable for reducing the bias that may be present in the historical customer dataset. Thus, the data points in each of the L1 clusters may be further clustered into a number of second level (L2) clusters. These L2 clusters are lower level clusters as compared with the L1 clusters and may represent more nuanced customer behaviors within each of the L1 clusters. For example, within an L1 cluster representing customers that visited the website, the L2 clusters may represent the customers that called for server support or customers that researched laptops online, among others. However, due to the bias that may be present in the historical customer dataset, the sizes of the L2 clusters may be imbalanced. For example, it may be the case that a very small number of the L2 clusters represent a very large percentage (e.g., 75%, 80%, 85%+) of the customers and the remaining large number of L2 clusters represent the remaining very small percentage (e.g., 25%, 20%, 15%, etc.) of customers. To address any imbalance that may be present in the L2 clusters, the size of the L2 clusters can be equalized (or substantially equalized) to remove the bias in the terms of overrepresented data in the historical customer data. For example, equal numbers (or close to equal numbers) of customers may be randomly sampled (selected) from each of the L2 clusters to achieve a uniform (or close to uniform) distribution across the L2 clusters. This in effect results in a down sampling of the larger L2 clusters and an up sampling of the smaller L2 clusters.

In some such embodiments, the customers from the clusters (e.g., the L2 clusters) may be sampled in a manner as to achieve a specified distribution of the customer behaviors. For example, a user (e.g., a system administrator) may have specified a target size (e.g., a number of training samples) for the training dataset and a target distribution or balance of the training samples in the training dataset. For example, suppose the user specified 100,000 training samples for the target size of the training dataset and a 20%-80% target distribution between customers that made a purchase and customers that did not make a purchase. In this example case, the sampling of the customers from the clusters may be performed to create a historical customer dataset that is as close to the target 100,000 training samples and the 20%-80% target distribution of customers that made a purchase and customers that did not make a purchase in the 100,000 training samples.

In some embodiments, the individual L1 clusters may be dimensionally reduced prior to clustering into L2 clusters. It is appreciated that clustering the dimensionally reduced historical customer dataset may cause variation in the data, causing different features to be identified within an L1 cluster. Dimensionality reduction of an L1 cluster can focus on these different features in reducing the dimensionality of the L1 cluster. Dimensionality reduction of the L1 cluster also retains some meaningful properties of the L1 cluster.

In some embodiments, the modeling process is in effect a generic process that can be used to generate different trained models that make different predictions. For example, depending on the structure of the training samples (e.g., how the independent variables and the dependent variable is structured in the training samples) the modeling process can be used to generate different trained models to predict different propensities, such as, by way of example, product failure propensity (e.g., likelihood that a product will fail), order return propensity (e.g., likelihood that a customer will return a purchased product), customer satisfaction propensity (e.g., likelihood that a customer will be satisfied), and product purchase propensity (e.g., likelihood that a customer is going to make a purchase).

In some embodiments, the modeling process can be used to perform what-if scenarios to simulate effectiveness (or impact) of a marketing campaign targeted at different segments of customers without launching the marketing campaign. For example, according to an embodiment, the input data (i.e., the training dataset) can be varied (structured) in different ways to target different segments or populations of the customers with a marketing campaign. In other embodiments, the input data may include new customer data collected subsequent to training of the model(s). In any case, the modeling process can then be run multiple times using the different variations of the input data (e.g., the different segments of the customers) to determine the effectiveness of the marketing campaign if targeted at the different segments of the customers. For example, suppose the input data is appropriately varied to create three different segments of the customers, e.g., a first variation of the input data to target a first segment of the customers, a second variation of the input data to target a second segment of the customers, and a third variation of the input data to target a third segment of the customers. In this example case, a first what-if scenario can be performed by running the modeling process using the first variation of the input data to simulate the effectiveness of the marketing campaign if targeted at the first segment of the customers. In similar manner, a second what-if scenario can be performed by running the modeling process using the second variation of the input data to simulate the effectiveness of the marketing campaign if targeted at the second segment of the customers, and a third what-if scenario can be performed by running the modeling process using the third variation of the input data to simulate the effectiveness of the marketing campaign if targeted at the third segment of the customers.

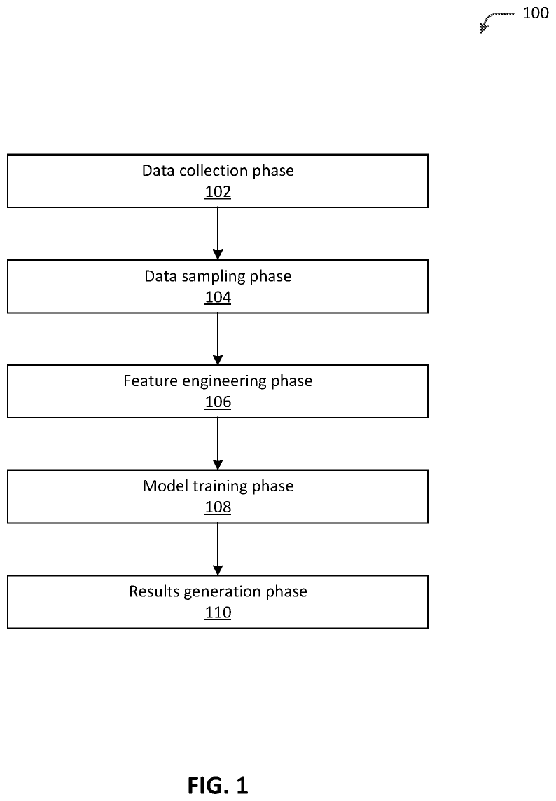

Referring now to the figures, FIG. 1 shows an illustrative workflow 100 for a propensity modeling process, in accordance with an embodiment of the present disclosure. As depicted, process 100 includes a data collection phase 102, a data sampling phase 104, a feature engineering phase 106, a model training phase 108, and a results generation phase 110. Process 100 can be performed by or on behalf of an enterprise, such as a business organization, company, corporation, governmental agency, educational institution, or the like, that engages in marketing.

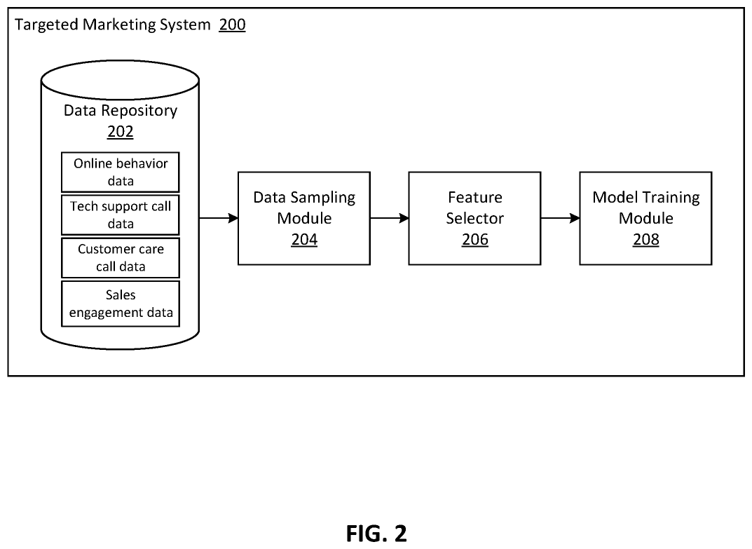

As described in further detail with respect to FIGS. 2-5, workflow 100 includes information collection from multiple data sources and generation of one or more ML models (e.g., propensity models) to enhance and, ideally optimize customer targeting for marketing campaigns. Briefly, in overview, data collection phase 102 includes collecting historical customer data for use in determining target customers for a marketing campaign. For example, an enterprise may collect the historical customer data from different units and/or data sources within the enterprise, such as sales teams, marketing teams, and customer relations teams, among others. The historical customer data is reflective of the whole, end-to-end customer journey through the different stages of the customers' consumption process. Such data may include the many touchpoints that customers have with the enterprise and the enterprise's brand. The collected historical customer data is input to the modeling process for use in training the learning model(s) and for segmenting of the input customer data (e.g., the input customers) for customer targeting.

Data sampling phase 104 includes sampling the historical customer dataset to identify different groups (e.g., clusters) within the historical customer dataset and to generate a balance between (i.e., balance out) the different groups within the historical customer dataset. Balancing the different groups that are present in the historical customer dataset reduces the inherent bias present in the historical customer dataset, meaning that the results of the modeling process are not focused on the majority (i.e., large) group(s) but, rather, focused on all groups that are present in the historical customer dataset. In some embodiments, the historical customer dataset may be sampled to meaningfully reduce the size of the historical customer dataset to a manageable size without comprise to the information conveyed by the historical customer dataset.

Feature engineering phase 106 includes determining the features that are to be used in training a learning model (e.g., a ML model) to predict a specific propensity. These features include the more relevant or predictive features (i.e., the features that add value to the desired ML model). These features may be derived from the historical customer dataset output from the data sampling phase. In some embodiments, a simple ML model may be trained and optimized to select the predictive features to use in generating a training dataset for use in training the ML model to predict a specific propensity.

Model training phase 108 includes training a ML model using machine learning techniques (e.g., supervised machine learning) with a training dataset to predict a specific propensity. The training dataset may include training samples generated or otherwise derived from any, some, or all of the features from the feature engineering phase. The trained ML model can provide, for example, as an output, unique predictions by customer segments. For example, one trained ML model can provide predictions of propensities of customers in a customer segment to make a purchase. As another example, another trained ML model can provide predictions of propensities of customers in a customer segment to call a technical support. As another example, still another trained ML model can provide predictions of propensities of customers in a customer segment to return a product. In any case, different ML models can be trained to provide predictions of different customer propensities.

Results generation phase 110 includes determining or otherwise identifying a list of customers to target in a marketing campaign based on the results of the modeling process. The list of customers may be determined based on the customer propensities predicted by the trained ML model. For example, based on the predicted propensities of customers to make a purchase, an optimal customer segment can be identified for a marketing campaign promoting a new product. As another example, based on the predicted propensities of customers to need technical assistance, an optimal customer segment can be identified for a marketing campaign promoting a technical support or assistance center. In general, the results of the modeling process allow for enhancing and, ideally optimizing customer targeting for various marketing campaigns.

FIG. 2 is a block diagram illustrating selective components of an example targeted marketing system 200 in which various aspects of the disclosure may be implemented, in accordance with an embodiment of the present disclosure. Targeted marketing system 200 can be configured to manage and orchestrate the propensity modeling process variously described herein. To this end, as depicted in FIG. 2, targeted marketing system 200 includes a data repository 202, a data sampling module 204, a feature selector module 206, and a model training module 208. Other componentry and modules typical of a typical computing system, such as, for example a co-processor, a processing core, a graphics processing unit, a mouse, a touch pad, a touch screen, display, etc., are not shown but will be readily apparent. Numerous computing environment variations will be apparent in light of this disclosure. For instance, data repository 202 may be external to targeted marketing system 200. Targeted marketing system 200 can be any stand-alone computing platform, such as a server computer, desktop or workstation computer, laptop computer, tablet computer, smart phone or personal digital assistant, or other suitable computing platform.

Data repository 202 may be a repository for the collected historical customer data and may be implemented using any computer-readable storage media suitable for carrying or having data or data structures stored thereon. This data may include information regarding all aspects of the whole, end-to-end journey of the enterprise's customers through the different stages of their consumption process. Such data may include the many touchpoints that customers have with the enterprise and the enterprise's brand. Thus, in some embodiments, data repository 202 can be understood as the storage point for the historical customer data that can be input or otherwise provided to the modeling process (e.g., data sampling module 204) for use in training the learning model(s) and for segmenting of the input customer data (e.g., the input customers) for customer targeting.

For example, as shown in FIG. 2, the historical customer data may include online behavior data, technical support call data, customer care call data, and sales engagement data. Online behavior data includes data collected regarding a customer's online behavior in interacting with the enterprise, such as information regarding the customer's activities on the enterprise's website. Online behavior data may be reflective of the pre-purchase and purchase stages of a customer's consumption process. As one example, online behavior data can include information regarding the number of product impressions made by the customer (e.g., how many times a product has been seen by the customer) over a period (e.g., by week, by month, by quarter, etc.). As another example, online behavior data can include information regarding the number of product type impressions made by the customer (e.g., how many times a product type has been seen by the customer) over a period. As another example, online behavior data can include information regarding the number of visits made by the customer to deals (e.g., pages offering deals), product pages, learn pages, and/or support pages. As another example, online behavior data can include information regarding the number of times the customer checked a status of an order (e.g., lookups in order status pages). Such information can be also categorized by product type. As another example, online behavior data can include information regarding the customer's site search keywords (e.g., keywords searched by the customer on the website). As another example, online behavior data can include information regarding the number of product purchases, product cart adds, and/or product checkout starts made by the customer over a period (e.g., by week, by 2 weeks, by month, by quarter, etc.). Such information can also be categorized by product type. As another example, online behavior data can include information regarding the number of newly introduced product lines (e.g., new product lines added to the enterprise's product portfolio) searched and/or visited by the customer. Such information can also be categorized by product type.

Technical call support data includes data collected regarding a customer's interactions with the enterprise's technical support center. Technical call support data may be reflective of the post-purchase stage of a customer's consumption process. As one example, technical call support data can include information regarding the total number of calls made by the customer to the technical support center. As another example, technical call support data can include information regarding the number of calls made by the customer that resulted in a technician being dispatched to address the issue(s). As another example, technical call support data can include information regarding the number of calls made by the customer that resulted in more than one dispatch to address the issue(s). As another example, technical call support data can include information regarding the number of calls made by the customer that took above average time to resolve (e.g., the number of the customer's calls that took longer than the average time taken to resolve all calls to the technical support center). As another example, technical call support data can include information regarding the number of times the customer accessed (e.g., logged into) the enterprise's support website to log or report a problem and the time spent by the customer on the support website. Some or all of the technical call support information can be categorized by product, product type, and/or totals.

Customer care call data includes data collected regarding a customer's interactions with the enterprise's customer care and/or customer relations unit. Customer care call data may also be reflective of the post-purchase stage of a customer's consumption process. As one example, customer care call data can include information regarding the number of calls made by the customer to the customer care and/or customer relations unit. As another example, customer care call data can include information regarding the number of the customer's orders where a scheduled delivery time was revised. As another example, customer care call data can include information regarding the number of products returned (e.g., product returns) by the customer. As another example, customer care call data can include information regarding the time taken to refund the customer for a product return. Some or all of the customer care call information can be categorized by product, product type, and/or totals.

Sales engagement data includes data collected regarding a customer's purchases of the enterprise's products. Sales engagement data may be reflective of the pre-purchase and purchase stages of a customer's consumption process. As one example, sales engagement data can include information regarding the percentage (%) of the customer's orders which were placed online. As another example, sales engagement data can include information regarding the percentage of the revenue generated by the customer's orders that is attributable to the customer's orders which were placed online. As another example, sales engagement data can include information regarding the number of quotes (e.g., product sales quotes) created for the customer over a period (e.g., by week, by month, by quarter, etc.). As another example, sales engagement data can include information regarding the average percentage of such quotes that were converted to orders over a period (e.g., by week, by month, by quarter, etc.).

It should be noted that the historical customer dataset can include other information or features than those shown in FIG. 2 and/or described above. For example, the historical customer dataset can also include demographic information regarding the customer. The historical customer dataset can also include information regarding other interactions between a customer and the enterprise. It should also be noted that the data collected for the customers may not include all the information or features described above. For example, for prospective customers (e.g., customers who did not make a purchase), the collected data may include some of the online behavior data but no technical call support data or customer care call data. As another example, the data collected for customers that did not call the technical support center may not include technical support call data. In general, examples of the historical customer data are provided herein for illustrative purposes only and are not intended to be limiting in this regard.

It is appreciated that machine learning algorithms use input data to create the outputs (the predictions). The input data comprise features (also called variables) that may be in the form of structured columns. It is also appreciated that in these machine learning algorithms, every instance may be represented by a row in the training dataset, where every column shows a different feature of the instance. Accordingly, the historical customer dataset may be stored in a tabular format in which the structured columns of the table represent different features (variables) regarding the customers and a row in the table represents a different customer. In some embodiments, the information contained in the table may be pre-processed to place the information into a format that is suitable for processing by data sampling module 204. For example, since machine learning deals with numerical values, textual categorical values (i.e., free text) in the columns (e.g., addresses, e.g., street, city, state, country, etc., names, products, search keywords, etc.) can be converted (i.e., encoded) into numerical values. Once the historical customer dataset is put into a format that is suitable for further processing, the historical customer dataset or a portion of the historical customer dataset (e.g., the table containing the historical customer dataset or a portion or portions of the table containing the historical customer dataset) may be input or otherwise provided to data sampling module 204.

Data sampling module 204 is configured to perform data sampling on the input dataset to reduce the number of input variables in the historical customer dataset. As explained above, the input dataset may be a high dimensional historical customer dataset that may be too voluminous in its raw state to be modeled by predictive modeling algorithms directly. Thus, data sampling can be performed to reduce the dimensionality of the high dimensional historical customer dataset into a much smaller, manageable dataset that can be modeled. This can be accomplished, for example, by removing the features that are irrelevant or add only little value in making the prediction. In other words, the features that are not helpful to making the prediction can be removed. For example, features that have a very small variance (e.g., less than a predetermined variance threshold) can be removed from the historical customer dataset. Particularly, the size of variance of a column in the table describes the amount of information in a variable, and the feature with too small variance is considered to contain little information for making the prediction. Thus, all the columns in the table with small variance can be removed. Dimension reduction can also be accomplished, for example, by removing redundant features from the historical customer dataset. For example, multiple columns in the table may be correlated in that they encode the same or very similar information. In such cases, the columns in the table that are redundant can be removed, leaving only one column that encodes the information.

Data sampling module 204 is also configured to perform data sampling on the input dataset to reduce any inherent bias that may be present in the historical customer dataset (e.g., dimensionally reduced historical customer data set). It is recognized that machine learning algorithms, such as decision trees, k-nearest neighbors, and neural networks, to provide a few examples, have a bias toward the overrepresented group(s) in that these algorithms tend only predict the majority group data. The features of the minority group(s) are treated as noise and are often ignored. Thus, there is a high probability of misclassification of the minority group(s) as compared to the majority group(s). As a result of the balancing of the distribution among the groups in a dataset, the model is able to learn from a balanced dataset. In other words, the model does not focus on a majority group(s) (i.e., overrepresented data) but, rather, considers all groups during the learning process.

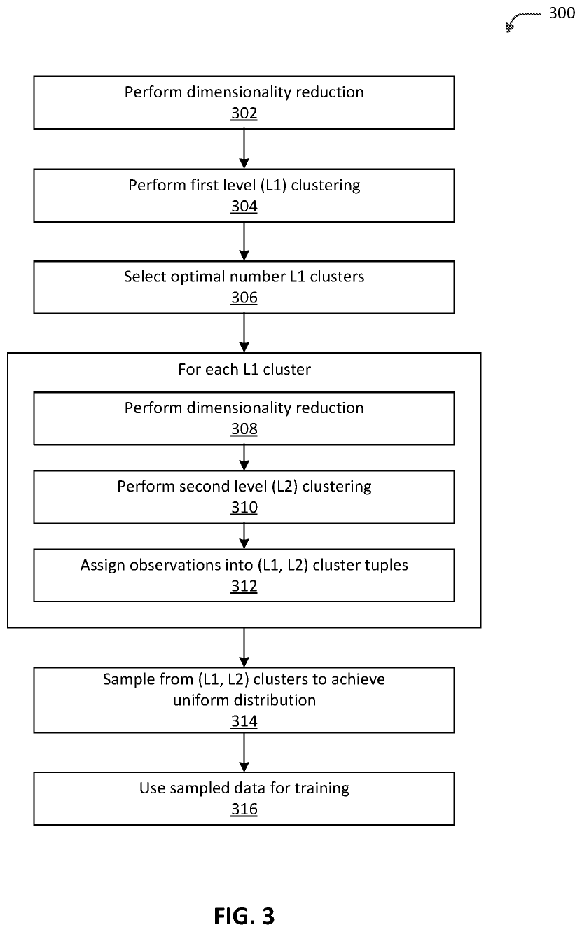

FIG. 3 is a flow diagram of an illustrative sampling process 300, in accordance with an embodiment of the present disclosure. For example, process 300 can be implemented by data sampling module 204 to reduce the dimensionality of and reduce any inherent bias that may present in the input historical customer dataset.

At block 302, dimensionality reduction of the input historical customer dataset may be performed to reduce the dimensionality of the historical customer dataset. For example, the input historical customer dataset may include a very large number of features. Dimensionality reduction can reduce the very large number of features to a much smaller number of features to better the predictive model. Any of a variety of dimensionality reduction techniques, such as singular-value decomposition (SVD), autoencoder, and linear discriminant analysis (LDA), among others, may be used to reduce the dimensionality of the historical customer dataset.

At block 304, a first level (L1) clustering of the data points in the dimensionally reduced historical customer dataset may be performed. For example, the L1 clustering may create clusters of customers based on broad, high-level themes. Any of a variety of clustering techniques, such as k-means and k-medoids, among others, may be used to cluster the data points in the dimensionally reduced historical customer dataset.

At block 306, an optimal number of L1 clusters may be selected. For example, the L1 clustering may generate some very small clusters (i.e., clusters containing a very small number of customers). In this case, some or all of these very small clusters may be combined into a single L1 cluster. In some embodiments, the optimal number of L1 clusters to select may be based on a tunable parameter. For example, the optimal number to select may be specified in a configuration file that is accessible by data sampling module 204, and a user (or system administrator) may tune or adjust the optimal number to select based on a desired performance of data sampling module 204. Any of a variety of techniques for determining the number of clusters in a dataset, such as elbow method and gap statistics, among others, may be used to determine the optimal number of L1 clusters in the dimensionally reduced historical customer dataset. Note that in some cases, the number of generated L1 clusters may be smaller than the specified optimal number.

The generated L1 clusters are groupings of customers that are based on broad, high level customer behaviors, such as, for example, customers that visited the website, customers for which only demographic data is collected, customers that called the technical support center, and customers that purchased a product, to name a few examples. Each of the L1 clusters can then be further stratified and clustered to capture more nuanced customer behaviors within the broad, high level customer behaviors. This can be accomplished by performing blocks 308-312 for each of the generated L1 clusters.

At block 308, dimensionality reduction of each L1 cluster may be performed to reduce the dimensionality of the customers (data points) that are included in an L1 cluster. For example, the L1 clustering may cause variation in the data, causing different features to be identified within the L1 cluster. Dimensionality reduction of the L1 cluster can focus on these features as well as the other features in reducing the dimensionality of the customers included in the L1 cluster. Similar to the dimensionality reduction performed above at block 302, any of a variety of dimensionality reduction techniques, such as SVD, autoencoder, and LDA, among others, may be used to reduce the dimensionality of the customers in each L1 cluster.

At block 310, a second level (L2) clustering of the data points in each dimensionally reduced L1 cluster may be performed. Similar to the clustering performed above at block 304, any of a variety of clustering techniques, such as k-means and k-medoids, among others, may be used to cluster the data points in each dimensionally reduced L1 cluster.

At block 312, all observations (i.e., customers) from the L2 clustering may be assigned into (L1, L2) cluster tuples. As a result, all the customers are assigned to or included in one of the L2 clusters. The L2 clustering may create clusters of customers based on more nuanced customer behaviors that the broad, high-level customer behaviors of the L1 cluster. For example, within an L1 cluster representing customers that visited the web site, a first L2 cluster may include customers that called for server support, a second L2 cluster may include customers that researched laptops online, a third L2 cluster may include customers that returned a product, and so on. As another example, within an L1 cluster representing customers that purchased a product, a first L2 cluster may include customers that purchased a computing device, a second L2 cluster may include customers that researched the product online, a third L2 cluster may include customers that returned the product that was purchased, and so on. In any case, due to the bias that may be present in the historical customer dataset, it may be the case that one, two, or another very small number of the L2 clusters represent a very large percentage (e.g., 80%, 85%, 90%, etc.) of the customers and the remaining number of L2 clusters, which may be a large number of clusters, represent the remaining small percentage of the customers. In other words, there may be an imbalance in the sizes of the L2 clusters (e.g., a small number of very large L2 clusters and a larger number of very small L2 clusters).

Upon stratifying and L2 clustering each of the L1 clusters, at block 314, equal numbers (or close to equal numbers) of customers may be randomly sampled (selected) from each the L2 clusters. Sampling equal numbers of customers from the L2 clusters achieves a uniform (or close to uniform) distribution across the L2 clusters and addresses any bias that may have been present in the historical customer dataset. Note that in some cases, equal numbers (or close to equal numbers) of customers may not be sampled from all of the L2 clusters. For example, there may be a small number of L2 clusters that each include only one or two or another very small number of customers while the remaining L2 clusters each include a much larger number of customers. In such cases, all of the customers that are in the small number of outliers (e.g., the small number of L2 clusters that include only a very small number of customers) can be sampled and an equal number of customers can be sampled from each of the remaining L2 clusters. In some embodiments, the customers from the L2 clusters may be sampled to achieve a specified distribution of customer behaviors.

At block 316, the data sampled from the L2 clusters may be used for training a learning model. For example, the features associated with the customers selected from the L2 clusters can be used to generate training samples for a training dataset, which in turn can be used to train a ML model to predict a specific propensity. In some embodiments, the data sampled from the L2 clusters may be further processed to identify the more relevant or predictive features, as will be further described below. In such embodiments, the data sampled from the L2 clusters can be input or otherwise provided to feature selector 206.

Referring again to FIG. 2, feature selector 206 is configured to determine the features that are to be used in training a learning model (e.g., a ML model) to predict a specific propensity. The determined features include the more relevant or predictive features, which are the features that are more correlated with the thing being predicted by the trained model (the dependent variable). While a variety of feature engineering techniques can be used to determine the more relevant features, in one embodiment, feature selector 206 can use variance analysis, covariance matrix, and/or a decision tree, to determine the features for training a ML model. In some embodiments, feature selector 206 can derive these features from the data (e.g., the data sampled from the L2 clusters) output from data sampling module 204.

Model training module 208 is configured to train a ML model using machine learning techniques (e.g., supervised machine learning) using a training dataset to predict a specific propensity. The training dataset may include training samples generated from the features output from or otherwise provided by feature selector 206. The trained ML model can predict the specific propensity for each of the customers included in the historical customer dataset that was input or otherwise provided to the modeling process (e.g., data sampling module 204). The predictions output from the trained ML model for the individual customers (e.g., likelihood that a customer in a specific region will make a purchase) can be used to determine whether to target a customer in a marketing campaign.

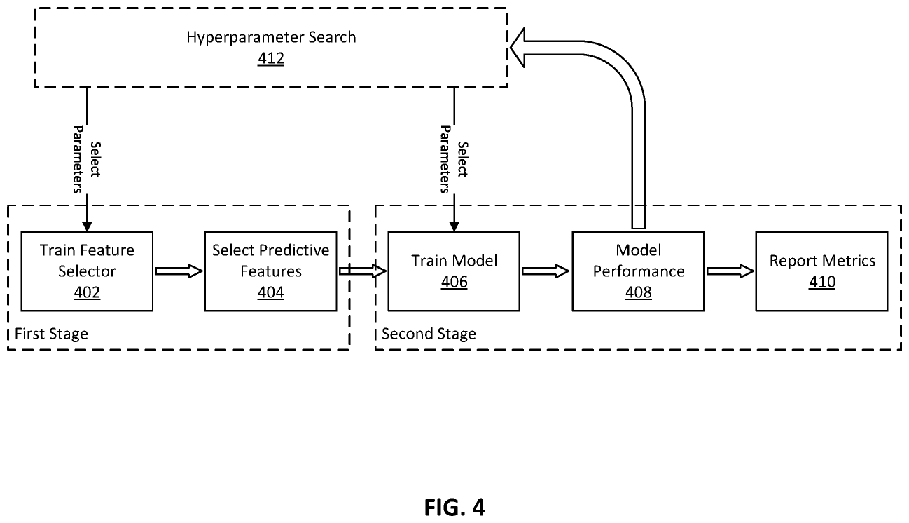

In an embodiment, as shown in FIG. 4, a feature selector (e.g., feature selector 206) and a ML model (e.g., a ML model trained by model training module 208) may be optimized in a two-stage manner. In some such embodiments, the feature selector may include a simple ML model, such as a random forest model. As can be seen in FIG. 4, in a first stage, the feature selector (e.g., a simple ML model) can be trained (402) using machine learning techniques (e.g., supervised machine learning) using a training dataset to predict a specific propensity. In some embodiments, the training dataset may include training samples generated from features derived from the data (e.g., the data sampled from the L2 clusters) output from data sampling module 204. Based on the predictions output from the simple ML model (i.e., the trained feature selector), a determination can be made as to which of the features are the more relevant or predictive features and which are the less relevant or less predictive, and the more relevant (more predictive) features can be selected (404). For example, logistic regression or other forms of regression, tree based algorithms, gradient boosting algorithms, random forest, or other simple model that is not costly to train can be used to determine feature relevance or predictiveness.

Still referring to FIG. 4, in a second stage, the selected more relevant features (i.e., the more relevant features from stage 1) can then be used to train (406) a ML model to predict the specific propensity. For example, training samples can be generated or otherwise derived from the selected relevant features and used as a training dataset to train the ML model. The ML model that is trained in stage 2 (referred to herein as a “production ML model) is the ML model that is used in the modeling process to predict the specific propensities of the customers. The performance of the models (e.g., the feature selector and the production ML model) can then be determined (408). For example, the models may be determined based on metrics such as loss, gain, and lift, to provide a few examples. The measured metrics can be reported (410), for example, for recording and/or use in evaluating the performance of the models.

It is appreciated that the feature selector (i.e., the simple ML model used for determining the more relevant features in stage 1) can be optimized by searching for the hyperparameters (412) that deliver the best performance as measured on a validation dataset, which may be a portion of the training dataset. Similarly, the production ML model can be optimized by searching for the hyperparameters (412) that deliver the best performance as measured on a validation dataset, which may be a portion of the training dataset. In some embodiments, the hyperparameters can be searched using techniques such as grid search, random search, Bayes search, or any other suitable hyperparameter tuning and/or search method.

The hyperparameters found for the feature selector can then be used with other parameters (e.g., the model parameters learned from the historical customer data) to train (402) the feature selector. Based on the predictions output from the trained feature selector, the more relevant features can be selected (404). The hyperparameters found for the production ML model can then be used with other parameters (e.g., the model parameters learned from the more relevant features selected in stage 1) to train (406) the production ML model. The performance of the models (e.g., the feature selector and the production ML model) can then be determined (408) and compared with the performance of the other previously created models to determine whether there is an improvement in performance. In other words, the performance of the models can be compared with the performance of the other previously created models to determine whether the models are being optimized. The feature selector and the production ML model optimizations can be continually or periodically performed to ensure that the models do not overfit and that the models are performing at an efficient level.

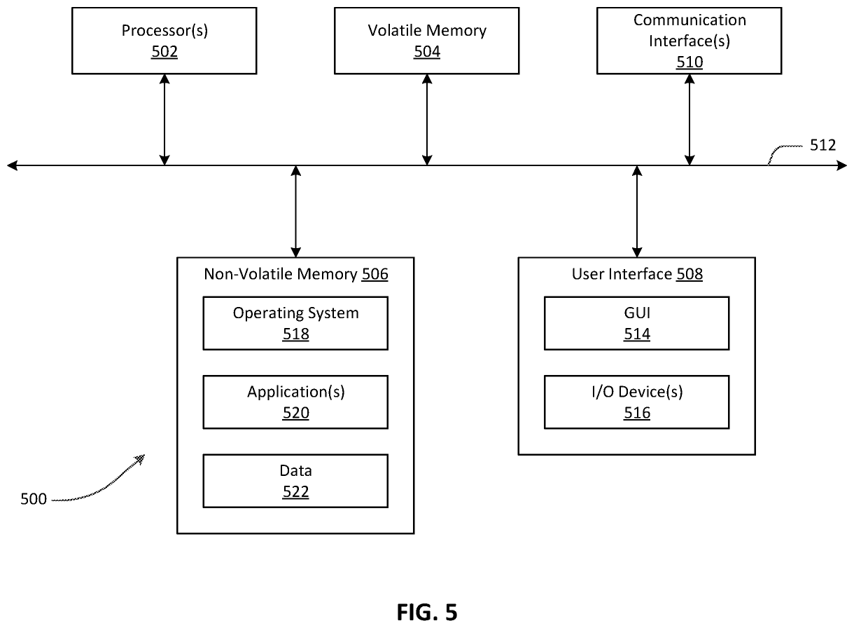

FIG. 5 is a block diagram illustrating selective components of an example computing device 500 in which various aspects of the disclosure may be implemented, in accordance with an embodiment of the present disclosure. For instance, targeted marketing system 200 of FIG. 2 can be substantially similar to computing device 500. As shown, computing device 500 includes one or more processors 502, a volatile memory 504 (e.g., random access memory (RAM)), a non-volatile memory 506, a user interface (UI) 508, one or more communications interfaces 510, and a communications bus 512.

Non-volatile memory 506 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 508 may include a graphical user interface (GUI) 514 (e.g., a touchscreen, a display, etc.) and one or more input/output (I/O) devices 516 (e.g., a mouse, a keyboard, a microphone, one or more speakers, one or more cameras, one or more biometric scanners, one or more environmental sensors, and one or more accelerometers, etc.).

Non-volatile memory 506 stores an operating system 518, one or more applications 520, and data 522 such that, for example, computer instructions of operating system 518 and/or applications 520 are executed by processor(s) 502 out of volatile memory 504. In one example, computer instructions of operating system 518 and/or applications 520 are executed by processor(s) 502 out of volatile memory 504 to perform all or part of the processes described herein (e.g., processes illustrated and described in reference to FIGS. 1 through 4). In some embodiments, volatile memory 504 may include one or more types of RAM and/or a cache memory that may offer a faster response time than a main memory. Data may be entered using an input device of GUI 514 or received from I/O device(s) 516. Various elements of computing device 500 may communicate via communications bus 512.

The illustrated computing device 500 is shown merely as an illustrative client device or server and may be implemented by any computing or processing environment with any type of machine or set of machines that may have suitable hardware and/or software capable of operating as described herein.

Processor(s) 502 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 502 may be analog, digital or mixed signal. In some embodiments, processor 502 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 510 may include one or more interfaces to enable computing device 500 to access a computer network such as a Local Area Network (LAN), a Wide Area Network (WAN), a Personal Area Network (PAN), or the Internet through a variety of wired and/or wireless connections, including cellular connections.

In described embodiments, computing device 500 may execute an application on behalf of a user of a client device. For example, computing device 500 may execute one or more virtual machines managed by a hypervisor. Each virtual machine may provide an execution session within which applications execute on behalf of a user or a client device, such as a hosted desktop session. Computing device 500 may also execute a terminal services session to provide a hosted desktop environment. Computing device 500 may provide access to a remote computing environment including one or more applications, one or more desktop applications, and one or more desktop sessions in which one or more applications may execute.

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A computer implemented method for customer targeting for a marketing campaign, the method comprising:
receiving a historical customer dataset, the historical customer dataset reflective of pre-purchase, purchase, and post-purchase stages of a consumption process of a plurality of customers;
identifying a plurality of first features, the plurality of first features derived from the historical customer dataset;
generating a first training dataset from the plurality of first features;
training a first machine learning (ML) model using the first training dataset;
determining, using the first ML model, a plurality of second features;
generating a second training dataset from the plurality of second features; and
training a second ML model using the second training dataset, wherein the second ML model is trained to output propensity predictions for the plurality of customers.

2. The method of claim 1, wherein identifying the plurality of first features comprises:
performing a first dimensionality reduction on the historical customer dataset;
clustering the first dimensionally reduced historical customer dataset into a plurality of first level (L1) clusters;
for each L1 cluster of the plurality of L1 clusters:
performing a second dimensionality reduction on data points in an L1 cluster; and
clustering the second dimensionally reduced data points in the L1 cluster into a plurality of second level (L2) clusters; and
sampling from the L2 clusters to achieve a uniform distribution of the L2 clusters.

3. The method of claim 2, wherein sampling from the L2 clusters to achieve a uniform distribution of the L2 clusters results in a reduction of inherent bias in the historical customer dataset.

4. The method of claim 2, wherein clustering the first dimensionally reduced historical customer dataset into the plurality of L1 clusters is via one of k-means clustering or k-medoids clustering.

5. The method of claim 2, wherein a number of L1 clusters in the plurality of L1 clusters is determined via one of an elbow method or gap statistics.

6. The method of claim 2, wherein the L2 clusters of the plurality of L2 clusters is more granular than the L1 clusters of the plurality of L1 clusters.

7. The method of claim 1, wherein the plurality of second features is more relevant to the propensity predictions than the plurality of first features.

8. The method of claim 1, wherein the propensity predictions include likelihood to make a purchase.

9. The method of claim 1, wherein the propensity predictions include likelihood to make a return.

10. The method of claim 1, wherein the propensity predictions include likelihood to require assistance.

11. A system comprising:
one or more non-transitory machine-readable mediums configured to store instructions; and
one or more processors configured to execute the instructions stored on the one or more non-transitory machine-readable mediums, wherein execution of the instructions causes the one or more processors to:
receive a historical customer dataset, the historical customer dataset reflective of pre-purchase, purchase, and post-purchase stages of a consumption process of a plurality of customers;
identify a plurality of first features, the plurality of first features derived from the historical customer dataset;
generate a first training dataset from the plurality of first features;
train a first machine learning (ML) model using the first training dataset;
determine, using the first ML model, a plurality of second features;
generate a second training dataset from the plurality of second features; and
train a second ML model using the second training dataset, wherein the second ML model is trained to output propensity predictions for the plurality of customers.

12. The system of claim 11, wherein to identify the plurality of first features comprises:
perform a first dimensionality reduction on the historical customer dataset;
cluster the first dimensionally reduced historical customer dataset into a plurality of first level (L1) clusters;
for each L1 cluster of the plurality of L1 clusters:
perform a second dimensionality reduction on data points in an L1 cluster; and
cluster the second dimensionally reduced data points in the L1 cluster into a plurality of second level (L2) clusters; and
sample from the L2 clusters to achieve a uniform distribution of the L2 clusters.

13. The system of claim 12, wherein to sample from the L2 clusters to achieve a uniform distribution of the L2 clusters results in a reduction of inherent bias in the historical customer dataset.

14. The system of claim 12, wherein to cluster the first dimensionally reduced historical customer dataset into the plurality of L1 clusters is via one of k-means clustering or k-medoids clustering.

15. The system of claim 12, wherein a number of L1 clusters in the plurality of L1 clusters is determined via one of an elbow method or gap statistics.

16. The system of claim 12, wherein the L2 clusters of the plurality of L2 clusters is more granular than the L1 clusters of the plurality of L1 clusters.

17. A computer program product including one or more non-transitory machine-readable mediums encoding instructions that when executed by one or more processors cause a process to be carried out for customer targeting for a marketing campaign, the process comprising:
receiving historical customer dataset, the historical customer dataset reflective of pre-purchase, purchase, and post-purchase stages of a consumption process of a plurality of customers;
identifying a plurality of first features, the plurality of first features derived from the historical customer dataset;
generating a first training dataset from the plurality of first features;
training a first machine learning (ML) model using the first training dataset;
determining, using the first ML model, a plurality of second features;
generating a second training dataset from the plurality of second features; and
training a second ML model using the second training dataset, wherein the second ML model is trained to output propensity predictions for the plurality of customers.

18. The computer program product of claim 17, wherein identifying the plurality of first features comprises:
performing a first dimensionality reduction on the historical customer dataset;
clustering the first dimensionally reduced historical customer dataset into a plurality of first level (L1) clusters; and
for each L1 cluster of the plurality of L1 clusters:
performing a second dimensionality reduction on data points in an L1 cluster; and
clustering the second dimensionally reduced data points in the L1 cluster into a plurality of second level (L2) clusters.

19. The computer program product of claim 18, wherein sampling from the L2 clusters to achieve a uniform distribution of the L2 clusters results in a reduction of inherent bias in the historical customer dataset.

20. The computer program product of claim 18, wherein the L2 clusters of the plurality of L2 clusters is more granular than the L1 clusters of the plurality of L1 clusters.
